(19) United States
(12) Patent Application Publication
(10) Pub. No.: US 2016/0004345 A1
(43) Pub. Date: Jan. 7, 2016

(54) VARYING A TOUCHSCREEN DISPLAY ATTRIBUTE IN RESPONSE TO USER INPUT

(71) Applicant: Kobo Inc., Toronto (CA)

(72) Inventor: Juan Ernesto Salas Imana, Toronto (CA)

(21) Appl. No.: 14/323,820

(22) Filed: Jul. 3, 2014

(51) Int. Cl. G06F 3/044

(52) U.S. Cl. CPC G06F 3/044

(57) ABSTRACT

A computing device includes a housing and a display assembly having a screen. The housing at least partially circumvents the screen so that the screen is viewable. The computing device further includes a set of touch sensors to receive user input. A processor is provided within the housing to detect the user input via the set of touch sensors, and to cycle a brightness of the screen of the display assembly in response to the user input. For example, the brightness of the screen may correspond with a contrast level of the screen and/or an illumination intensity of one or more light sources used to illuminate the screen.

### TECHNICAL FIELD

Examples described herein relate to a computing device that provides feedback in response to user input by varying a touchscreen display attribute.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reader device or other electronic personal display device, for use with one or more embodiments described herein.

FIGS. 3A-3B illustrate an e-reader device that responds to user input by cycling an illumination intensity of a display screen.

FIGS. 4A-4B illustrate an e-reader device that responds to user input by cycling a contrast level of a display screen.

FIG. 5 illustrates an e-reader system for displaying paginated content, according to one or more embodiments.

FIG. 6 illustrates a method of providing visual confirmation of user inputs on an e-reader device, according to one or more embodiments.

### DETAILED DESCRIPTION

Embodiments described herein provide for a computing device that responds to user input by varying a touchscreen display attribute. More specifically, the computing device may provide confirmation or acknowledgement of the user input by cycling the brightness of a display screen. For example, the computing device may cycle the brightness of the display screen by temporarily increasing the illumination (e.g., backlight) intensity and/or contrast level of the display.

According to some embodiments, a computing device includes a housing and a display assembly having a screen. The housing at least partially circumvents the screen so that the screen is viewable. A set of touch sensors are provided with the computing device to receive user input. A processor detects the user input via the set of touch sensors and cycles a brightness of the screen of the display assembly in response to the user input. For example, the display assembly may include one or more light sources to provide illumination for the screen. Thus, the brightness of the screen may correspond with an intensity of the illumination. Alternatively, and/or in addition, the brightness of the screen may correspond with a contrast level of the screen.

The brightness of the screen may be set to a first brightness setting prior to receiving the user input. The processor may thus cycle the brightness of the screen by adjusting the brightness of the screen to a second brightness setting and, after a predetermined duration, returning the brightness of the screen to the first brightness setting. For some embodiments, the processor may adjust the brightness of the screen based, in part, on the first brightness setting. For example, the processor may increase the brightness of the screen if the first brightness setting is below a brightness threshold. On the other hand, the processor may decrease the brightness of the screen if the first brightness setting is above the brightness threshold. For some embodiments, the second brightness setting may be based, at least in part, on a degree of ambient light surrounding the computing device.

Among other benefits, examples described herein enable a computing device to provide instantaneous visual feedback to a user in response to detecting a user input. For example, many e-ink display technologies suffer from inherently low refresh rates (e.g., 200 ms or longer). As a result, there is often a lag between the time a user provides an input (e.g., a page-turn input) to an e-ink device and the time the device updates its display screen to reflect the input. This lag may cause the user to think that the device did not detect the original input. As a result, the user may often repeat the same input several times, causing the device to process more inputs (e.g., turn more pages) than the user had originally intended. However, by cycling the brightness of the display screen, the device may provide an immediate visual confirmation or acknowledgement that it has received the user input.

One or more embodiments described herein provide that methods, techniques and actions performed by a computing device are performed programmatically, or as a computer-implemented method. Programmatically means through the use of code, or computer-executable instructions. A programmatically performed step may or may not be automatic. As used herein, the terms “cycle” or “cycling” the brightness of a display means temporarily altering one or more brightness settings from their original state, and subsequently returning the brightness settings back to their original state.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

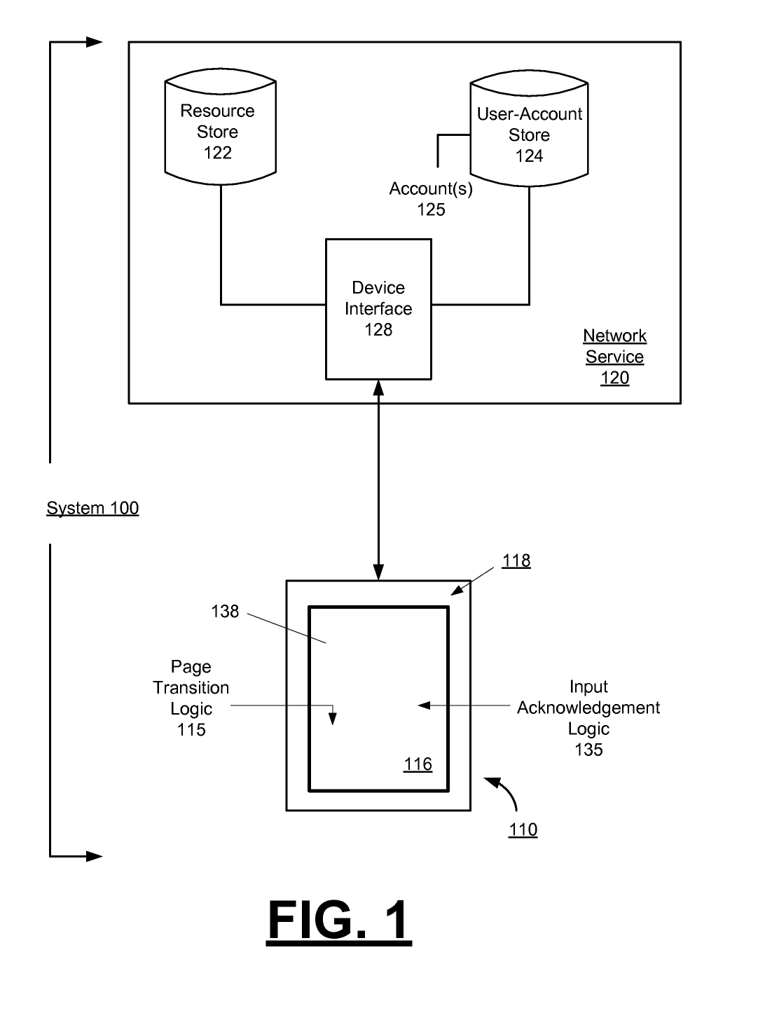

FIG. 1 illustrates a system 100 for utilizing applications and providing e-book services on a computing device, according to an embodiment. In an example of FIG. 1, system 100 includes an electronic display device, shown by way of example as an e-reader device 110, and a network service 120. The network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application that receives files or streaming data from the network service 120. By way of example, the e-reader device 110 can be equipped with hardware and software to optimize certain application activities, such as reading electronic content (e.g., e-books). For example, the e-reader device 110 can have a tablet-like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With reference to an example of FIG. 1, e-reader device 110 can include a display screen 116 and a housing 118. In an embodiment, the display screen 116 is touch-sensitive, to process touch inputs including gestures (e.g., swipes). For example, the display screen 116 may be integrated with one or more touch sensors to provide a touch sensing region on a surface of the display screen 116. Additionally, the housing 118 can be integrated with touch sensors to provide one or more touch sensing regions, for example, on the bezel and/or back surface of the housing 118.

In some embodiments, the e-reader device 110 includes features for providing functionality related to displaying paginated content. The e-reader device can include page transitioning logic 115, which enables the user to transition through paginated content. The e-reader device can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display 116. For example, the user can trigger a page turn (e.g., a forward or backward page transition) input by tapping the surface of the display 116. Alternatively, and/or additionally, the user may trigger a page turn input by swiping the surface of the display 116 (e.g., in the direction of the desired page transition).

According to some embodiments, the e-reader device 100 includes input acknowledgement logic 135 to detect and respond to user input made through interaction with one or more touch sensing regions of the display 116 and/or the housing 118. More specifically, the input acknowledgement logic 135 may provide a visual confirmation or acknowledgement to the user in response to detecting the user input, for example, by cycling a brightness of (e.g., “flashing”) the display 116. For some embodiments, the input acknowledgement logic 135 may cycle the brightness of the display 116 by varying an illumination intensity provided by one or more light sources (such as a backlight) used to illuminate the display 116. For other embodiments, the input acknowledgement logic 135 may cycle the brightness of the display 116 by varying a contrast level of the display 116.

By way of example, the input acknowledgement logic 135 can detect a user making contact with the touch sensing region of the display 116. The user contact may correspond with a page-turning input such as, for example, a forward page turn. Upon detecting the user input, the input acknowledgement logic 135 may briefly increase (or decrease) the brightness of the display 116 before returning the brightness to its original brightness setting (e.g., the brightness setting prior to receiving the user input). For some embodiments, the input acknowledgement logic 135 may cycle the brightness of the display 116 in less time than the page transition logic 115 takes to change the content on the display 116 (e.g., by transitioning to a different page).

Hardware Description

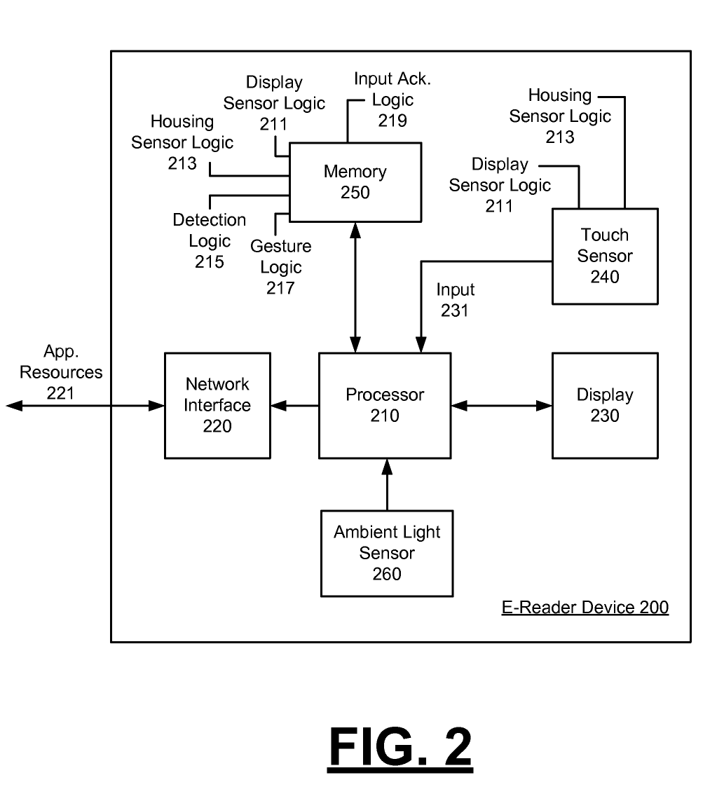

FIG. 2 illustrates an example of an e-reader device 200 or other electronic personal display device, for use with one or more embodiments described herein. In an example of FIG. 2, an e-reader device 200 can correspond to, for example, the device 110 as described above with respect to FIG. 1. With reference to FIG. 2, e-reader device 200 includes a processor 210, a network interface 220, a display 230, one or more touch sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources 221, such as e-books or media files, that the user elects to purchase or otherwise download from the network service 120. The application resources 221 that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. The memory 250 may further store housing sensor logic 213 that monitors for user interactions detected through the touch sensor components 240 provided with portions of the housing of the e-reader device 200. In an alternative embodiment, the display sensor logic 211 and/or the housing sensor logic 213 may be integrated with the touch sensor components 240. For example, one or more of the touch sensor components 240 can be provided as modular components that include integrated circuits or other hardware logic, and such resources can provide some or all of the display sensor logic 211. In variations, some or all of the display sensor logic 211 and/or housing sensor logic 213 may be implemented with the processor 210 (which utilizes instructions stored in the memory 250), or with an alternative processing resource.

In one implementation, the display sensor logic 211 and/or housing sensor logic 213 may further include detection logic 215 and gesture logic 217. The detection logic 215 implements operations to monitor for the user contacting a surface of the housing and/or display coinciding with the placement of one or more sensors. The gesture logic 217 detects and correlates a particular gesture (e.g., swiping, tapping, pinching, etc.) as a particular type of input or user action. The gesture logic 217 can also detect directionality so as to distinguish between, for example, leftward or rightward swipes.

The memory 250 further stores input acknowledgement logic 219 to respond to provide a visual cue or feedback in response to inputs 231 received via the touch sensor components 240. For example, upon receiving a user input 231 via one or more of the touch sensor components 240, the input acknowledgement logic 219 may provide a visual confirmation or acknowledgment of the received input 231 by cycling a brightness of the display 230. For example, the input acknowledgement logic 219 may cycle the brightness of the display 230 by varying a contrast level of the display 230 and/or by varying an illumination intensity provided by one or more light sources (e.g., a backlight) used to illuminate the display 230.

For some embodiments, the input acknowledgement logic 219 may cycle the brightness “up” or “down” based on the relative brightness of the display 230 at (or prior to) the time the input 231 is received. For example, the display 230 may be originally set to a user-configured brightness setting (e.g., contrast level and/or illumination intensity). The input acknowledgement logic 219 may thus determine whether to increase the brightness of the display 230 (e.g., cycle the brightness up) or decrease the brightness of the display 230 (e.g., cycle the brightness down) in response to the received input 231, depending on the original brightness setting of the display 230. For some embodiments, the input acknowledgement logic 219 may cycle the brightness of the display 230 in a manner that produces an optimal perceived visual response. For example, if the display 230 is already above a threshold brightness setting (e.g. above 50% of the maximum possible brightness), the input acknowledgement logic 219 may cycle the brightness level down. On the other hand, if the display 230 is below the threshold brightness setting (e.g., below 50% of the maximum possible brightness), the input acknowledgement logic 219 may cycle the brightness level up.

Still further, for some embodiments, the input acknowledgement logic 219 may determine the magnitude of the change in brightness based on ambient light detected by an ambient light sensor 260. Specifically, the ambient light sensor 260 may detect a degree (e.g., amount and/or intensity) of ambient light in the environment surrounding the e-reader device 200. For some embodiments, the input acknowledgement logic 219 may determine a magnitude for the brightness cycle that produces an optimal perceived visual response. For example, if the surrounding environment is very bright, the input acknowledgement logic 219 may increase (or decrease) the brightness of the display 230 by a significant margin (e.g., 100% of the maximum brightness setting) in order to provide an effective visual confirmation to the user. In contrast, if the surrounding environment is very dim, the input acknowledgement logic 219 may increase (or decrease) the brightness of the display 230 by a much smaller margin (e.g., 25% of the maximum brightness setting).

The duration of the visual confirmation cycle (e.g., the length of time the new brightness setting is held before reverting to the original brightness setting) may be a predetermined length such that the visual confirmation is perceived as a “flash” to the user of the device 200. For some embodiments, the duration of the cycle may not exceed a refresh rate of the display 230. For example, in response to receiving an input 231, the input acknowledgement logic 219 may alter the brightness setting of the display 230 and return the brightness setting to its original state before the contents of the display 230 are updated. Further, for some embodiments, the duration of the cycle may be configurable by the user of the device 200.

Visual Input Confirmation

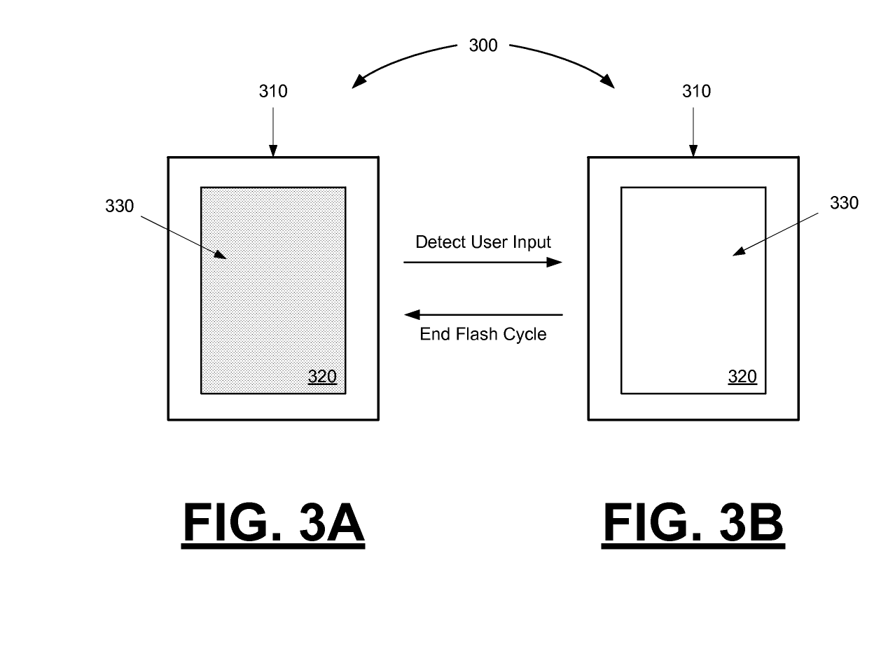

FIGS. 3A-3B illustrate an e-reader device that responds to user input by cycling an illumination intensity of a display screen. The e-reader device 300 includes a housing 310 and a display screen 320. The e-reader device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

The housing 310 and/or display screen 320 may be integrated with one or more touch sensors. More specifically, the e-reader device 300 can integrate one or more types of touch-sensitive technologies in order to provide touch-sensitivity on a surface of the housing 310 and/or the display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

The e-reader device 300 may further include a backlight 330 to provide illumination for the display 320. The backlight 330 may be comprised of one or more light-emitting diodes (LEDs), an electroluminescent panel (ELP), one or more fluorescent lamps, and/or one or more incandescent light bulbs. For example, one or more components of the backlight 330 may be provided under the display 320, to illuminate the display 320 from behind. Alternatively, and/or in addition, one or more components of the backlight 330 may be provided within the bezel of the housing 310, to provide side illumination to the display 320 (e.g., from one or more edges of the display). Still further, in some implementations, the e-reader device 300 may be illuminated from the front.

For some embodiments, the e-reader device 300 may respond to user input received via the one or more touch sensors provided with the housing 310 and/or the display 320 by cycling a the illumination intensity of the backlight 330. More specifically, the e-reader device 300 may temporarily increase or decrease the illumination intensity of the backlight 330 to provide visual feedback indicating that the user input was successfully received. The visual feedback may be perceived by the user as a “flash” of illumination by the backlight 330. For example, the duration of the flash cycle may not exceed a refresh rate of the display 320. For some embodiments, the duration of the flash cycle may be configurable by the user of the e-reader device 300.

In a particular example, the device 300 may determine that the original illumination intensity of the backlight 330 is below a threshold illumination level (e.g., causing the display 320 to appear relatively “dim”). Thus, upon detecting a user input, the e-reader device 300 may cycle up the illumination intensity of the backlight 330. For example, as shown in FIG. 3B, the device 300 may respond to user input by immediately increasing the illumination intensity of the backlight 330 (e.g., causing the display 320 to appear “brighter”). As described above, actual illumination intensity of the backlight 330, in FIG. 3B, may depend on a degree of ambient light in the surrounding environment (e.g., detected by an ambient light sensor). Thus, the change in illumination intensity may be greater (or more intense) in brighter lighting environments compared to dimmer lighting environments. At the end of the flash cycle, the e-reader device 300 may lower the illumination intensity of the backlight 330 back to its original state prior to receiving the user input (e.g., as shown in FIG. 3A). More generally, the e-reader device 300 may either cycle the illumination intensity up or down, in response to user input, depending on the original illumination intensity level of the backlight 330.

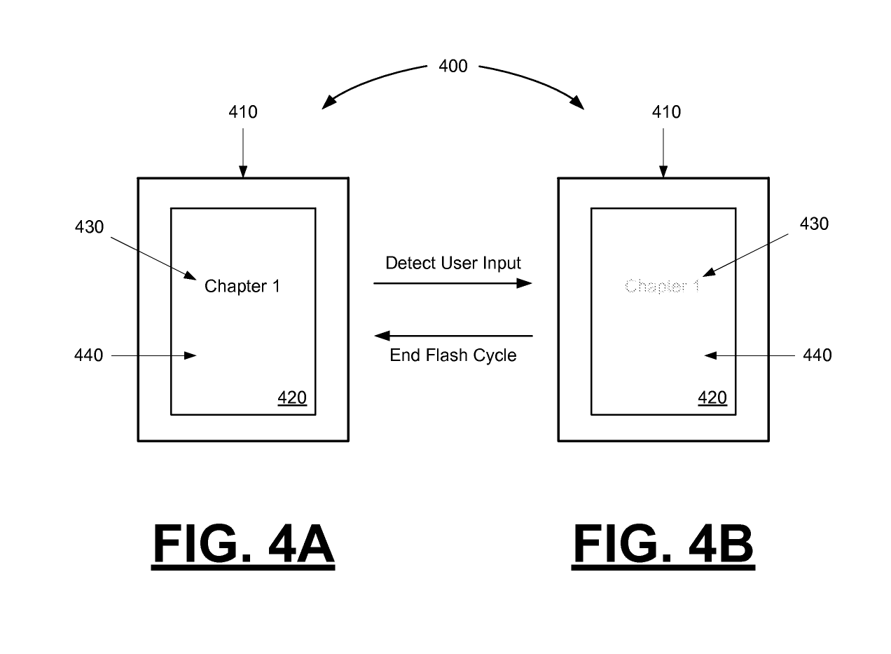

FIGS. 4A-4B illustrate an e-reader device that responds to user input by cycling a contrast level of a display screen. The e-reader device 400 includes a housing 410 and a display screen 420. For simplicity, the shape and design of the e-reader device 400 may be substantially similar to that of e-reader device 300 described above, with respect to FIG. 3. Furthermore, the housing 410 and display screen 420 may include substantially the same features, and perform substantially similar functions, as the corresponding housing 310 and display screen 320 of FIG. 3. For example, the housing 410 and/or display screen 420 may be integrated with one or more touch sensors to provide touch-sensitivity on one or more surfaces of the housing 410 and/or display screen 420.

For some embodiments, the e-reader device 400 may respond to user input received via the one or more touch sensors provided with the housing 410 and/or the display 420 by cycling a contrast level of the display 420. For example, the display 420 may include content 430 (e.g., text, images, and/or other viewable content) that is presented against a background 440 of the display 420. The contrast level of the display 420 affects the visibility of the content 430 relative to the background of the display 420. Thus, the e-reader device 400 may temporarily increase or decrease the contrast level of the display 420 to provide visual feedback indicating that a user input was successfully received. The visual feedback may be perceived by the user as a “flash” of content 430 presented on the display 420. As described above, the duration of the flash cycle may not exceed a refresh rate of the display 420. For some embodiments, the duration of the flash cycle may be configurable by the user of the e-reader device 400.

In a particular example, the background 440 of the display 420 is a relatively light color (such as white, gray, silver, or beige). Furthermore, the device 400 may determine that the original contrast level of the display 420 is above a threshold contrast level (e.g., causing the content 430 to appear relatively dark against the background 440). Thus, upon detecting a user input, the e-reader device 400 may cycle down the contrast level of the display 420. For example, as shown in FIG. 4B, the device 400 may respond to user input by immediately lowering the contrast level of the display 420 (e.g., causing the content 430 to appear lighter or more “washed out”). As described above, the actual contrast level of the display 420, in FIG. 4B, may depend on a degree of ambient light in the surrounding environment (e.g., detected by an ambient light sensor). Thus, the change in contrast level may be greater in brighter lighting environments compared to dimmer lighting environments. At the end of the flash cycle, the e-reader device 400 may increase the contrast level of the display 420 back to its original state prior to receiving the user input (e.g., as shown in FIG. 4A). More generally, the e-reader device 400 may either cycle the contrast level up or down, in response to user input, depending on the original contrast level of the display 420 and/or a relative darkness of the background 440.

Page Transition Functionality

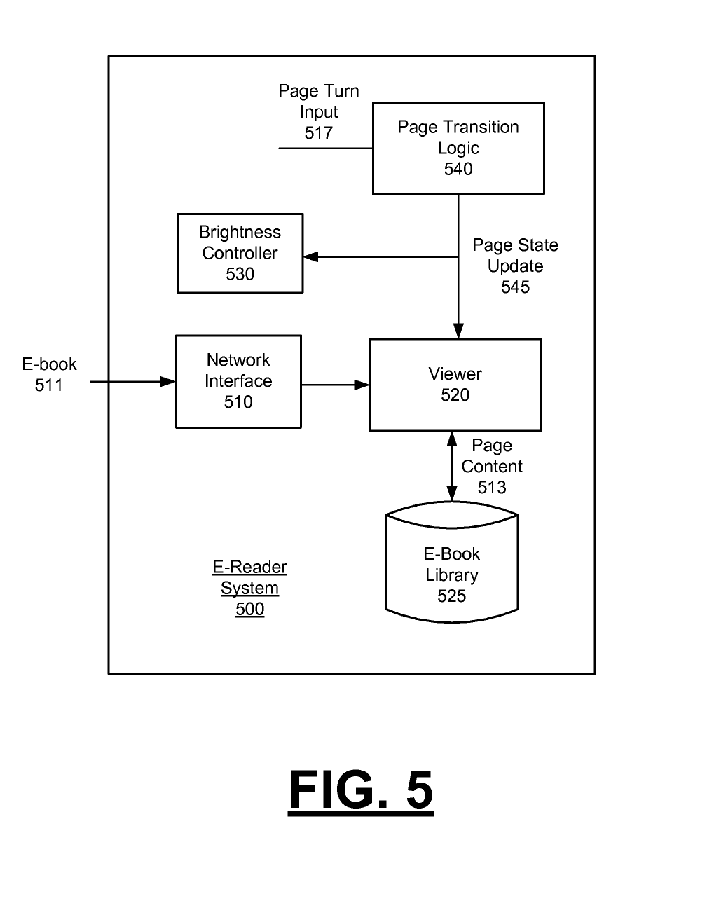

FIG. 5 illustrates an e-reader system for displaying paginated content, according to one or more embodiments. An e-reader system 500 can be implemented as, for example, an application or device, using components that execute on, for example, an e-reader device such as shown with examples of FIGS. 1, 2, 3A-3B, and 4A-4B. Furthermore, an e-reader system 500 such as described can be implemented in a context such as shown by FIG. 1, and configured as described by an example of FIG. 2, FIGS. 3A-3B, and/or FIGS. 4A-4B.

In an example of FIG. 5, a system 500 includes a network interface 510, a viewer 520 and device state logic 540. As described with an example of FIG. 1, the network interface 510 can correspond to a programmatic component that communicates with a network service in order to receive data and programmatic resources. For example, the network interface 510 can receive an e-book 511 from the network service that the user purchases and/or downloads. E-books 511 can be stored as part of an e-book library 525 with memory resources of an e-reader device (e.g., see memory 250 of e-reader device 200).

The viewer 520 can access page content 513 from a selected e-book, provided with the e-book library 525. The page content 513 can correspond to one or more pages that comprise the selected e-book. The viewer 520 renders one or more pages on a display screen at a given instance, corresponding to the retrieved page content 513. The page state can correspond to a particular page, or set of pages that are displayed at a given moment.

The page transition logic 540 can be provided as a feature or functionality of the viewer 520. Alternatively, the page transition logic 540 can be provided as a plug-in or as independent functionality from the viewer 520. The page transition logic 540 can signal page state updates 545 to the viewer 520. The page state updates 545 can specify a page transition, causing the viewer 520 to render a new page. In specifying the page state update 545, the page transition logic 540 can provide for single page turns, multiple page turns, or chapter turns. The page state update 545 for a single page turn causes the viewer 520 to transition a page state by presenting page content 513 that is next in sequence (e.g., forward or backward) to the page content that is being displayed. The page state updated 545 for a multi-page turn causes the viewer 520 to transition a page state by presenting page content 513 that is a jump forward or backward in sequence from the page state under display. Likewise, the page state update 545 for a chapter turn causes the viewer 520 to transition a page state by presenting page content 513 that is a subsequent or previous chapter in sequence to a chapter of the current page state. Accordingly, the page state update 545 can signify a transition value representing the page sate that is to be displayed next (e.g., one page transition or ten page transition) or a transition type (e.g., page versus chapter transition).

According to some embodiments, the page transition logic 540 can be responsive to different kinds of input, including an input action which signifies page turns (or page transitions) 517. The page turn input 517 can include, for example, single page turns, mufti-page turns and/or chapter turns. The type of page turn input 517 can be determined from the type of input provided. For example, the page turn input 517 can be provided by the user interacting with the one or more touch sensors provided on a surface of a housing and/or display of the e-reader system 500. Specifically, single taps on the touch sensors may be interpreted as single page turns, whereas a touch-and-hold can be interpreted as a multi-page turn or chapter input. Still further, actions such as a tap and swipe can be interpreted as a chapter transition.

In response to receiving a page turn input 517, the page transition logic 540 signals the page state update 545 to the viewer 520. The viewer updates the page content 513 to reflect the change represented by the page state update 545 (e.g., single page transition, multi-page transition, or chapter transition). For some embodiments, the page state update 545 is additionally provided to a brightness controller 530 which cycles a brightness of a display of the e-reader system 500 (e.g., as described above with respect to FIGS. 1, 2, 3A-3B, and 4A-4B). For example, in response to receiving a page state update 545, the brightness controller 530 may cycle the illumination intensity and/or contrast level of the display up or down to provide a visual confirmation that the page turn input 517 was successfully received by the e-reader system 500. For some embodiments, the duration of the visual confirmation cycle may not exceed a length of time needed by the viewer 520 to render the updated page content 513 on the display screen.

It should be noted that by enabling the brightness controller 530 to be responsive to page state updates 545 (e.g., rather than directly responding to page turn inputs 517), the risk of generating “false” visual confirmations may be reduced. For example, as described above, the page transition logic 540 may interpret user inputs of various types (e.g., tap, tap-and-hold, swipe, pinch, etc.). The present configuration leverages the capabilities of the page transition logic 540 to distinguish between various user inputs, to ensure that the brightness controller 530 provides a visual confirmation only after the intended input has been detected. For example, this may prevent the brightness controller 530 from immediately cycling the brightness of the display upon detecting a finger tap, when the intended input is in fact a tap-and-hold.

Methodology

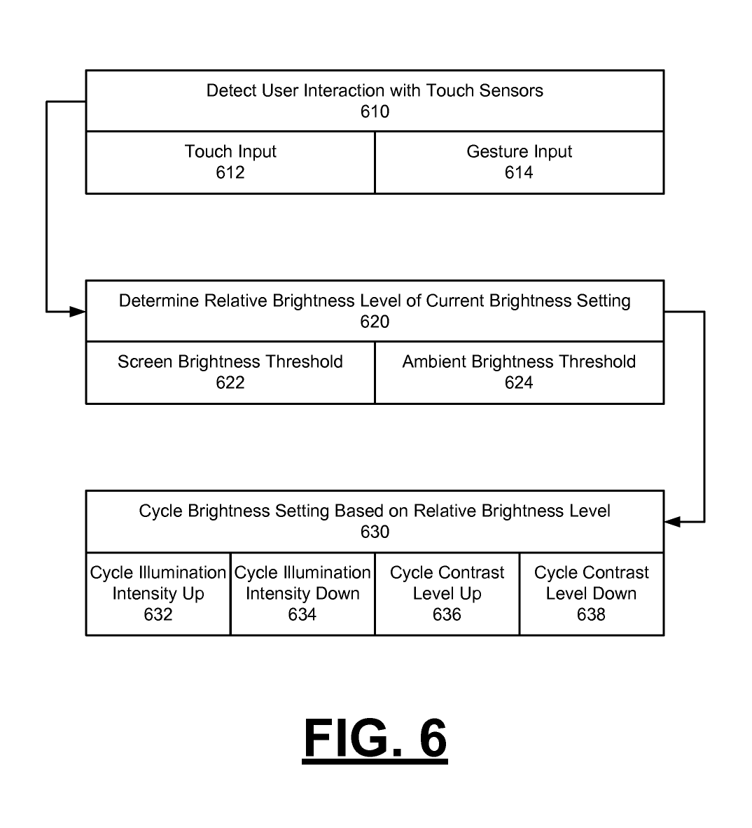

FIG. 6 illustrates a method of providing visual confirmation of user inputs on an e-reader device, according to one or more embodiments. In describing an example of FIG. 6, reference may be made to components such as described with FIGS. 2, 3A-3B, and 4A-4B for purposes of illustrating suitable components for performing a step or sub-step being described.

With reference to an example of FIG. 2, the e-reader device 200 may detect a user interaction with one or more touch sensors provided (or otherwise associated) with the display 230 and/or housing of the e-reader device 200 (610). For example, the processor 210 can receive inputs 231 from the touch sensor components 240. More specifically, the processor 210, in executing the display sensor logic 211 and/or housing sensor logic 213, may monitor for touch-based inputs (612) and/or gesture-based inputs (614) on one or more surfaces of the e-reader device 200. For example, the processor 210 may interpret the user interactions with the one or more touch sensors to distinguish between various types of input.

The e-reader device 200 may then determine a relative brightness level of a current brightness setting of the display 230 (620). For example, the processor 210, in executing the input acknowledgement logic 219, may analyze the current brightness configuration of the display 230 (e.g., illumination intensity, contrast level, and/or ambient light) to determine what type of brightness adjustments may produce an optimal visual confirmation for the user. For example, the input acknowledgement logic 219, as executed by the processor 210, may compare the current illumination intensity and/or contrast level of the display 230 with respective illumination and/or contrast thresholds (622) to determine whether to cycle the brightness of the display 230 up or down. Further, the input acknowledgment logic 219, as executed by the processor 210, may compare the degree (e.g., amount and/or intensity) of ambient light in the surrounding environment with an ambient light threshold (624) to determine the magnitude by which to increase or decrease the current brightness setting.

Finally, the e-reader device 200 may cycle the brightness setting of the display 230 based on the relative brightness level of the current brightness setting (630). For example, the processor 210, in executing the input acknowledgement logic 219, may cycle the brightness of the display 230 up or down (e.g., by increasing or decreasing the corresponding illumination intensity and/or contrast level of the display 230). Specifically, the processor 210 may cycle the illumination intensity up (632) if the current illumination intensity is below the illumination threshold. Alternatively, the processor 210 may cycle the illumination intensity down (634) if the current illumination intensity is above the illumination threshold. Further, the processor 210 may cycle the contrast level up (636) if the current contrast level is below the contrast threshold. Alternatively, the processor 210 may cycle the contrast level down (638) if the current contrast level is above the contrast threshold.

As described above, the magnitude of the change in brightness (e.g., illumination intensity and/or contrast level) of the display 230 may depend on the ambient light of the surrounding environment. For example, the change in illumination intensity may be greater if the degree of ambient light is above the ambient light threshold. In contrast, the change in illumination intensity may be lower if the degree of ambient light is below the ambient light threshold.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a set of touch sensors to receive user input; and
a processor provided within the housing, the processor operating to:
detect the user input via the set of touch sensors; and
cycle a brightness of the screen of the display assembly in response to the user input.

2. The computing device of claim 1, wherein the brightness of the screen corresponds with a contrast level of the screen.

3. The computing device of claim 1, wherein the display assembly further includes one or more light sources to provide illumination for the screen, and wherein the brightness of the screen corresponds with an intensity of the illumination.

4. The computing device of claim 1, wherein the brightness of the screen is set to a first brightness setting prior to receiving the user input.

5. The computing device of claim 4, wherein the processor is to cycle the brightness of the screen by:
adjusting the brightness of the screen to a second brightness setting; and
after a predetermined duration, returning the brightness of the screen to the first brightness setting.

6. The computing device of claim 5, wherein the processor is to adjust the brightness of the screen based, at least in part, on the first brightness setting.

7. The computing device of claim 6, wherein the processor is to adjust the brightness of the screen by:
increasing the brightness of the screen if the first brightness setting is below a brightness threshold; and
decreasing the brightness of the screen if the first brightness setting is above the brightness threshold.

8. The computing device of claim 5, further comprising:
a light sensor to detect a degree of ambient light surrounding the computing device.

9. The computing device of claim 8, wherein the second brightness setting is based, at least in part, on the degree of ambient light detected by the light sensor.

10. The computing device of claim 1, wherein a response time for cycling the brightness of the screen is faster than a refresh rate of the display assembly.

11. A method for operating a computing device, the method being implemented by one or more processors and comprising:
detecting a user input via a set of touch sensors provided with the computing device; and
cycling a brightness of a screen of the computing device in response to the user input.

12. The method of claim 11, wherein the brightness of the screen corresponds with a contrast level of the screen.

13. The method of claim 11, wherein the brightness of the screen corresponds with an intensity of one or more light sources used to illuminate the screen.

14. The method of claim 11, wherein the brightness of the screen is set to a first brightness setting prior to receiving the user input.

15. The method of claim 14, wherein cycling the brightness of the screen comprises:
adjusting the brightness of the screen to a second brightness setting; and
after a predetermined duration, returning the brightness of the screen to the first brightness setting.

16. The method of claim 15, wherein adjusting the brightness of the screen comprises:
adjusting the brightness of screen based, at least in part, on the first brightness setting.

17. The method of claim 16, wherein adjusting the brightness of the screen further comprises:
increasing the brightness of the screen if the first brightness setting is below a brightness threshold; and
decreasing the brightness of the screen if the first brightness setting is above the brightness threshold.

18. The method of claim 15, wherein adjusting the brightness of the screen comprises:
detecting a degree of ambient light surrounding the computing device; and
adjusting the brightness of the screen based, at least in part, on the degree of ambient light.

19. The method of claim 18, wherein adjusting the brightness of the screen further comprises:
increasing the brightness of the screen if the degree of ambient light is below an ambient light threshold; and
decreasing the brightness of the screen if the degree of ambient light is above the ambient light threshold.

20. A non-transitory computer-readable medium that stores instructions, that when executed by one or more processors, cause the one or more processors to perform operations that include:
detecting a user input via a set of touch sensors provided with the computing device; and
cycling a brightness of a screen of the computing device in response to the user input.
